(19) United States
(12) Patent Application Publication
(10) Pub. No.: US 2026/0277343 A1
(43) Pub. Date: Sep. 17, 2026

(54) MULTI-FUNCTIONAL PEN WITH INTEGRATED LASER RANGING AND ILLUMINATION

(71) Applicant: SHENZHEN MAMMOTH ELECTRONIC CO., LTD, Shenzhen (CN)

(72) Inventor: Yanfang Zeng, Meizhou (CN)

(21) Appl. No.: 19/670,686

(22) Filed: May 7, 2026

(30) Foreign Application Priority Data
Apr. 20, 2026 (CN) 202610523652.6

(51) Int. Cl. G06F 3/0354; G06F 3/038

(52) U.S. Cl. CPC G06F 3/03545; G06F 3/0386

(57) ABSTRACT

Disclosed is a multi-functional pen with integrated laser ranging and illumination, including a first pen barrel with a display screen module and an interactive input assembly, and a pen clip with a protrusion. A laser transmitting module of a laser ranging assembly is disposed in the pen clip protrusion, and a laser receiving part is disposed inside the first pen barrel where a refill body is coaxially disposed, and a pen tip direction is opposite to a ranging transmission and reception direction. A Hall knob control assembly is sleeved outside the pen barrel for interaction, and a linkage power supply structure is disposed inside the pen barrel. When the pen tip is rotatably extended, a circuit is conducted to light up a light emitting unit. A ranging optical path is integrated into a compact pen body configuration for efficient operation with two ends for measurement, illumination and recording without interference.

### CROSS-REFERENCE TO RELATED APPLICATIONS

This application claims priority to Chinese Patent Application No. 202610523652.6, filed on April 20, 2026, which is hereby incorporated by reference in its entirety.

### TECHNICAL FIELD

The present invention relates to the technical field of writing instruments and photoelectric measuring devices, and in particular to a multi-functional pen with integrated laser ranging and illumination.

### BACKGROUND

In working scenarios such as building construction, interior design, on-site surveys, and daily office work, staff often need to obtain dimensional distances of target objects and immediately write down measurement data. Currently, staff commonly adopt an operating method of holding a rangefinder in the left hand, and a pen and a record book in the right hand. However, existing conventional writing pens have only a single function and cannot provide measurement assistance; after completing measurements with a separate laser ranging device, operators often need to put it down or place it in their pockets to free up their hands for writing. This operating method of frequently alternating between a measuring tool and a writing instrument is cumbersome. It not only reduces on-site work efficiency, but also easily causes slip-off and damage to a device at a complicated construction site lacking desktop support.

With the development of electronic component miniaturization technology, some electronic pens with additional functions have gradually emerged on the market. To achieve electronic menu scrolling and command confirmation, these multi-functional pens are usually provided with holes at lateral sides of pen bodies and fitted with a plurality of traditional micro keys. However, due to extremely limited surface areas and internal space of the pen bodies, the layout of physical keys is often very cramped, and users are highly prone to accidental touches during blind operation in a pen-holding state; moreover, traditional keys or detent wheels lack a comfortable and distinct tactile sensation feedback of physical detents, leading to a poor menu selection experience. In addition, mechanical assembly gaps unavoidably exist between traditional keys and a pen housing, resulting in easy ingress of external moisture and dust into the interior of a pen body through such gaps, which in turn leads to a short circuit or oxidation of an internal PCB and poor overall protection performance of the device.

Furthermore, for data recording carried out in dimly lit working environments, such as underground garages, night construction sites and weak current shaft troubleshooting, traditional writing pens fail to provide sufficient visibility of a paper surface. Although some writing pens with an illumination function exist in the prior art, illumination circuits of these writing pens are turned on and off by mostly relying on an independently arranged mechanical toggle switch or push switch. Users need to distract their attention additionally to locate and manually turn on an illumination switch before writing preparation; a more prominent pain point is that users often forget to turn off the independent illumination switch after finishing writing and retracting the refill, causing an already limited battery level inside the device to be consumed ineffectively for a long time. Meanwhile, a separately arranged illumination switch and a wiring structure thereof can also further occupy valuable assembly space inside the pen barrel, and this is unfavorable for highly integrated design of multi-functional pens.

### SUMMARY

In view of the deficiencies of the prior art, the present invention provides a multi-functional pen with integrated laser ranging and illumination, and solves the problems that the existing conventional writing instruments have only a single function, necessitate frequent alternation between a rangefinder and a pen in ranging and recording scenarios, and bring poor portability and operability; the existing multi-functional pens with electronic features suffer from cramped layout of interactive switches, cumbersome operation and lack of a tactile feedback of detents; and for writing in dimly lit environments, traditional lighted pens require users to turn illumination on and off by manually looking for and pressing an independent switch, and this involves more operating steps and easily causes the problem of power loss due to forgetting to turn off the light.

To achieve the above objectives, the present invention is implemented through the following technical solution:

A multi-functional pen with integrated laser ranging and illumination, including a first pen barrel, wherein a pen clip with a protrusion is fixedly connected to one side of an outer wall of the first pen barrel, a pen PCB is fixedly connected inside the first pen barrel, the first pen barrel is provided with a display screen module and at least one interactive input assembly, and a light emitting unit for providing illumination and a coaxially disposed refill body are arranged inside the first pen barrel;

a laser ranging assembly is disposed inside the first pen barrel and the pen clip, the laser ranging assembly includes a laser transmitting module and a laser receiving part, the laser transmitting module is disposed inside the protrusion of the pen clip, and the laser receiving part is disposed at an intermediate position inside the first pen barrel; a direction of the pen tip of the refill body is opposite to a direction of ranging transmission and reception of the laser ranging assembly.

Preferably, the laser receiving part includes a laser receiving window lens, a laser receiving lens, a laser receiving mirror and a photoelectric sensor, wherein the laser transmitting window lens is disposed at the protrusion at a top end of the pen clip and located above the laser transmitting module, the laser receiving window lens is disposed at an inner side of a top end of the first pen barrel, the laser receiving lens is disposed below the laser receiving window lens, the laser receiving mirror is disposed obliquely below the laser receiving lens, and the photoelectric sensor is fixedly connected inside the first pen barrel and located at one side below the laser receiving mirror.

Preferably, the laser ranging assembly further includes a ranging module bracket, a first laser rangefinder module, a second laser rangefinder module, a receiving lens sheet bracket, a mirror bracket, and a filter, the ranging module bracket is fixedly connected inside the first pen barrel, the first laser rangefinder module and the second laser rangefinder module are fixedly connected to an outer side of the ranging module bracket, the receiving lens sheet bracket and the mirror bracket are fixedly connected on an inner wall of the ranging module bracket, the laser receiving lens and the filter are fixedly connected inside the receiving lens sheet bracket, and the laser receiving mirror is fixedly connected to an outer surface of the mirror bracket.

Preferably, a display screen bracket is fixedly connected to one side of an outer wall of the first pen barrel, a display screen module is fixedly connected inside the display screen bracket, a display window lens is disposed at an outer surface of the display screen bracket, a device body adapter and a bottom cover are fixedly connected to a bottom end inside the first pen barrel, a TYPE-C interface is fixedly connected inside the bottom cover, and a battery is disposed inside the first pen barrel at a position close to an upper side of the device body adapter.

Preferably, a Hall knob control assembly is sleeved on an outer wall of the first pen barrel, the Hall knob control assembly includes a knob key, first magnets, Hall sensors and a knob reset magnet, the knob key is rotatably connected to an outer side of the first pen barrel, a plurality of the first magnets are fixedly connected in a circular array on an inner wall of the knob key, two of the Hall sensors are fixedly connected to an outer surface of the pen PCB, and the knob reset magnet is fixedly connected on an outer wall of the first pen barrel and correspondingly disposed at an inner side of the first magnets.

Preferably, the Hall knob control assembly further includes a ball stud, a first key and a first waterproof ring, a groove is formed in an inner wall of the knob key, the ball stud is slidably connected inside the groove, the first key is fixedly connected on an outer wall of the pen PCB, the first waterproof ring is sleeved on an inner wall of the first pen barrel, and one end of the ball stud extends into the first waterproof ring and abuts against an outer side of the first key.

Preferably, an illumination assembly is disposed below the device body adapter, the illumination assembly includes a casing refill extending and retracting barrel, a barrel grip, a negative conductive refill extending and retracting sleeve, an insulating refill extending and retracting sleeve and a refill body, wherein a top end of the casing refill extending and retracting barrel is fixedly connected on an outer wall of the device body adapter, the barrel grip is rotatably connected to an outer side of the casing refill extending and retracting barrel, the negative conductive refill extending and retracting sleeve is rotatably connected inside the casing refill extending and retracting barrel, a refill extending and retracting threaded guide slot is formed in an inner wall of the negative conductive refill extending and retracting sleeve, an outer wall of the insulating refill extending and retracting sleeve is fixedly connected with an guide slot pin for insulating refill sleeve extension and retraction, the guide slot pin for insulating refill sleeve extension and retraction is slidably connected inside the refill extending and retracting threaded guide slot, and the refill body is slidably connected inside the insulating refill extending and retracting sleeve.

Preferably, the illumination assembly further includes a spring-loaded pin, a pen positive adapter conductive female connector, a positive insulating sleeve, a refill conductive sheet and a refill top conductive spring, wherein the spring-loaded pin is fixedly connected to a bottom end of the pen PCB, the pen positive adapter conductive female connector abuts against a lower side of the spring-loaded pin, the positive insulating sleeve is sleeved on an outer wall of the pen positive adapter conductive female connector, the refill conductive sheet is fixedly connected on an outer wall of the refill body, the refill top conductive spring is in contact connection with a top end of the refill body, and a top end of the refill top conductive spring abuts against a lower surface of the pen positive adapter conductive female connector.

Preferably, the illumination assembly further includes an insulating refill retaining ring, a refill extending and retracting limiter and a second waterproof ring, wherein the insulating refill retaining ring is fixedly connected to a bottom end of an inner wall of the casing refill extending and retracting barrel, the refill extending and retracting limiter is disposed at an inner side of the insulating refill retaining ring, and the second waterproof ring is sleeved on an outer wall of the casing refill extending and retracting barrel near an inner wall of the barrel grip.

Preferably, the illumination assembly further includes a light emitting unit, a refill lamp PCB positive electrode guide ring and a refill lamp light guide ring, wherein the light emitting unit is fixedly connected to a bottom end inside the casing refill extending and retracting barrel, the refill lamp PCB positive electrode guide ring is fixedly connected above the light emitting unit, and the refill lamp light guide ring is sleeved around the light emitting unit.

Preferably, the illumination assembly further includes a refill extending and retracting spring, a refill lamp positive electrode conductive spring and a refill lamp negative conductive wave spring, wherein the refill extending and retracting spring is sleeved on an outer wall of the refill body, the refill lamp positive electrode conductive spring is sleeved on a bottom end of the refill body, and the refill lamp negative conductive wave spring is disposed around the bottom end of the refill body; when the refill body slides downward, a bottom end of the refill lamp positive electrode conductive spring abuts against an upper surface of the refill lamp PCB positive electrode guide ring.

The present invention provides a multi-functional pen with integrated laser ranging and illumination. The present invention has the following beneficial effects:
1. The present invention breaks through internal space limitations of traditional multi-functional pens by innovatively adopting a separated spatial layout. The laser transmitting module is ingeniously concealed within the protrusion of the pen clip, while the large-volume laser receiving part is arranged at the intermediate position of the pen barrel. This layout not only ensures a complete laser transmitting and receiving optical path, but also maintains a slim grip feeling of the writing pen. Meanwhile, an extension direction of the coaxially disposed internal refill is completely opposite to the direction of ranging transmission and reception, forming a structure with one end for precise ranging and the other end for writing and recording without mutual interference. This greatly enhances the continuity of on-site operations and the portability of the device. In addition, the internal supporting special optical brackets further ensure the precise refraction of the optical path to prevent optical path deviation caused by assembly tolerances.
2. The present invention provides a Hall knob control assembly sleeved on the outer wall of the pen barrel. The magnets at the inner wall of the knob key are used in conjunction with the internal Hall sensors to recognize rotation signals for menu operations. Alternating magnetic attraction and repulsion forces are generated through the knob reset magnet at the outer wall and a rotating magnet to provide users with a distinct tactile detent sensation during rotation. Meanwhile, the design of triggering confirmation keys in conjunction with squeezing the waterproof ring by the ball stud in the groove inside the knob key not only achieves quick single-finger interaction for menu scrolling and press-to-confirm, but also ensures sealing and waterproofing of internal circuit components. This effectively avoids the defects of traditional multi-key layouts, which are cramped, prone to accidental touches, and susceptible to damage due to water ingress.
3. The present invention designs a linkage structure for writing actions and illumination on-off. The internal adapter conductive female connector, the refill body and the conductive springs at both ends are connected in series to form a positive power supply loop. When a user rotates the barrel grip to extend the refill downward for writing preparation, the refill lamp positive electrode conductive spring sleeved on the bottom of the refill is compressed accordingly and physically abuts against the bottom electrode conductive ring, so that the power supply loop is instantly conducted, and the front-end light emitting unit is illuminated; when the refill is retracted, the spring disengages naturally, and the loop is disconnected accordingly. This structure eliminates the cumbersome steps of manually looking for and pressing the independent switch, achieving instant light-on upon refill extension and automatic light-off upon refill retraction. This not only saves a limited structural space inside the pen barrel, but also fundamentally avoids the problem of power loss due to forgetting to turn off the light.

### BRIEF DESCRIPTION OF THE DRAWINGS

FIG. 1 is a perspective view of the multi-functional pen with integrated laser ranging and illumination of the present invention.

FIG. 2 is a schematic structural diagram of a battery part of the multi-functional pen with integrated laser ranging and illumination of the present invention.

FIG. 3 is a schematic structural diagram of a refill part of the multi-functional pen with integrated laser ranging and illumination of the present invention.

FIG. 4 is a schematic structural diagram of a refill extending and retracting limiter part of the multi-functional pen with integrated laser ranging and illumination of the present invention.

FIG. 5 is a schematic diagram of position A in FIG. 2 of the present invention.

FIG. 6 is a schematic diagram of position B in FIG. 4 of the present invention.

FIG. 7 is a schematic diagram of position C in FIG. 3 of the present invention.

FIG. 8 is a schematic structural diagram of a pen PCB part of the multi-functional pen with integrated laser ranging and illumination of the present invention.

In the figures, 1. Laser receiving window lens; 2. Display screen bracket; 3. Display window lens; 4. Display screen module; 5. First pen barrel; 6. Pen cover; 7. Pen clip; 701. Laser receiving lens; 702. Laser receiving mirror; 703. Photoelectric sensor; 704. Filter; 705. Receiving lens sheet bracket; 706. Ranging module bracket; 707. Mirror bracket; 708. First laser rangefinder module; 709. Second laser rangefinder module; 710. Laser transmitting module; 8. Laser transmitting window lens; 9. Pen PCB; 901. Hall sensor; 902. First key; 903. TYPE-C interface; 904. Spring-loaded pin; 905. Light emitting unit; 906. Refill lamp PCB positive electrode guide ring; 10. Battery; 11. Knob key; 1101. First magnet; 12. Knob reset magnet; 13. Ball stud; 14. Bottom cover; 15. Device body adapter; 16. First waterproof ring; 17. Casing refill extending and retracting barrel; 18. Pen positive adapter conductive female connector; 19. Positive insulating sleeve; 20. Insulating refill extending and retracting sleeve; 2001. Guide slot pin for insulating refill sleeve extension and retraction; 21. Refill conductive sheet; 22. Negative conductive refill extending and retracting sleeve; 2201. Refill extending and retracting threaded guide slot; 23. Refill body; 24. Barrel grip; 25. Second waterproof ring; 26. Insulating refill retaining ring; 27. Refill extending and retracting limiter; 28. Refill lamp positive electrode conductive spring; 29. Refill extending and retracting spring; 30. Refill lamp negative conductive wave spring; 31. Refill lamp light guide ring; 32. Refill top conductive spring.

### DESCRIPTION OF EMBODIMENTS

The technical solution in the embodiments of the present invention will be described clearly and completely below in conjunction with the accompanying drawings in the embodiments of the present invention. Obviously, the embodiments described are only a part of, rather than all of, the embodiments of the present invention. Based on the embodiments in the present invention, all other embodiments obtained by those of ordinary skill in the art without making creative efforts should fall within the protection scope of the present invention.

### Embodiment

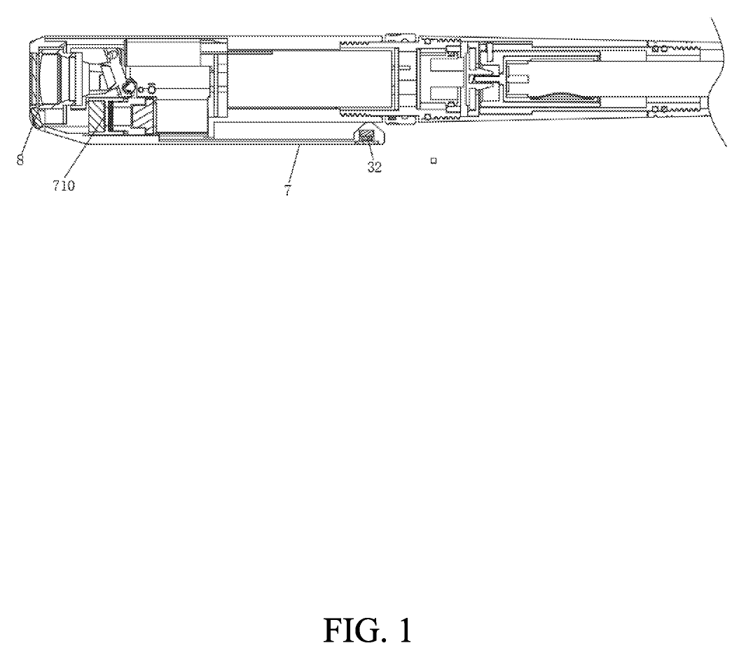

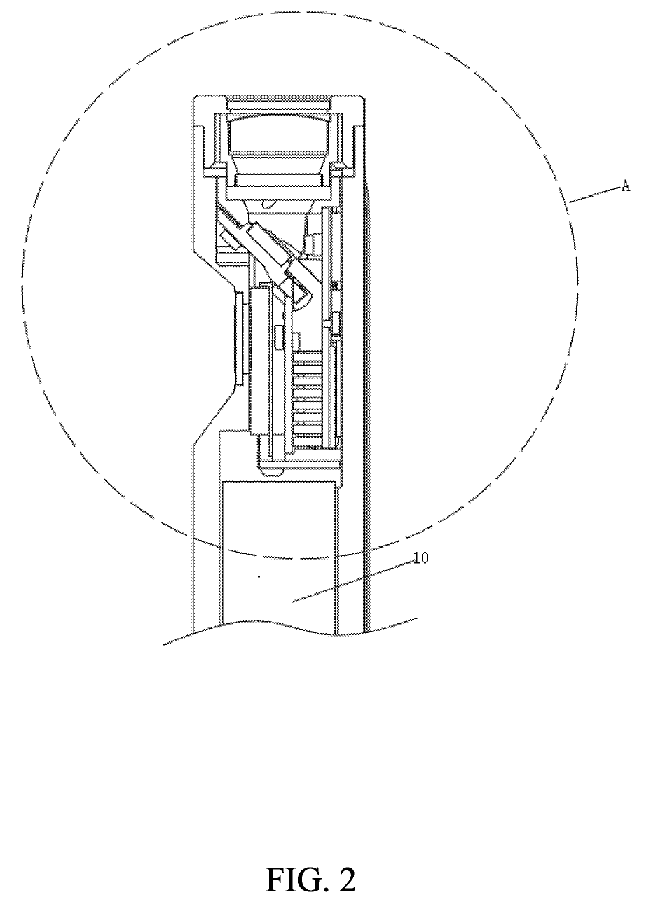

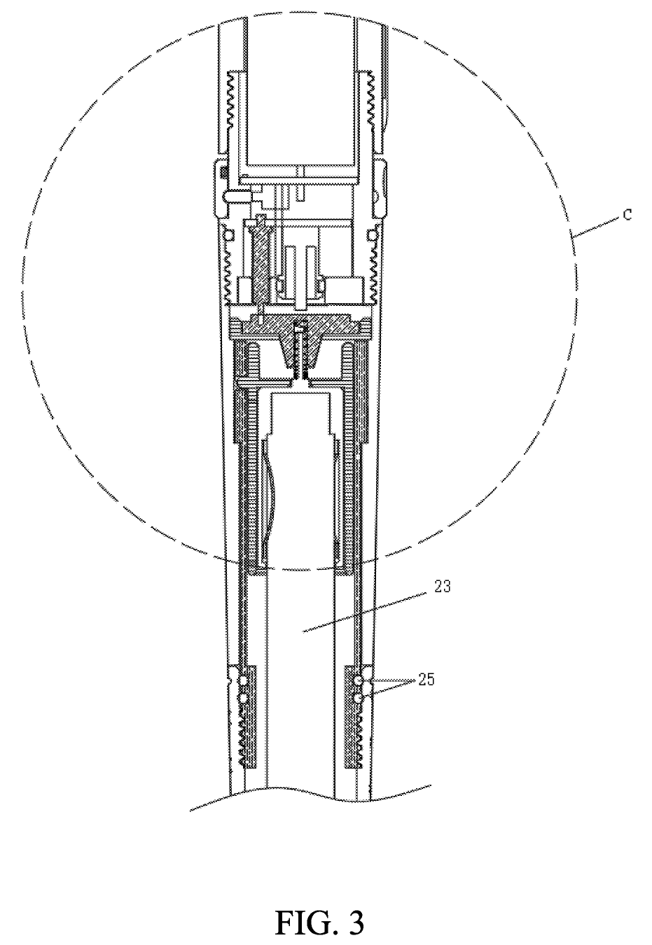

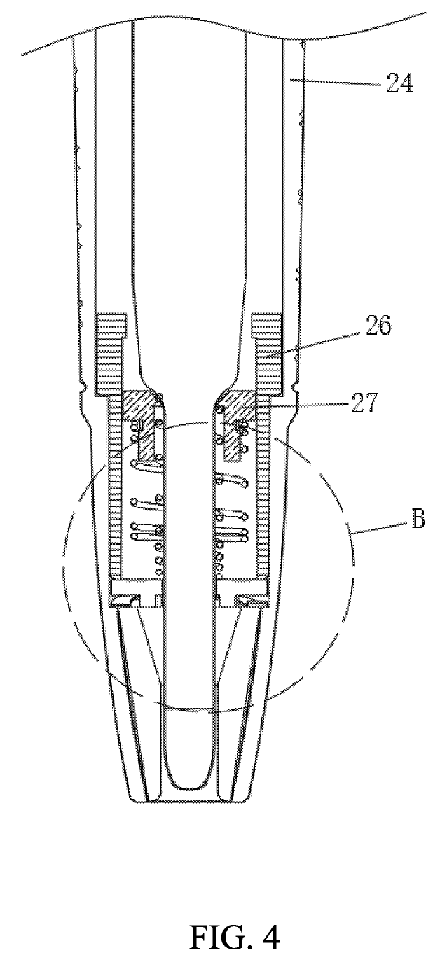

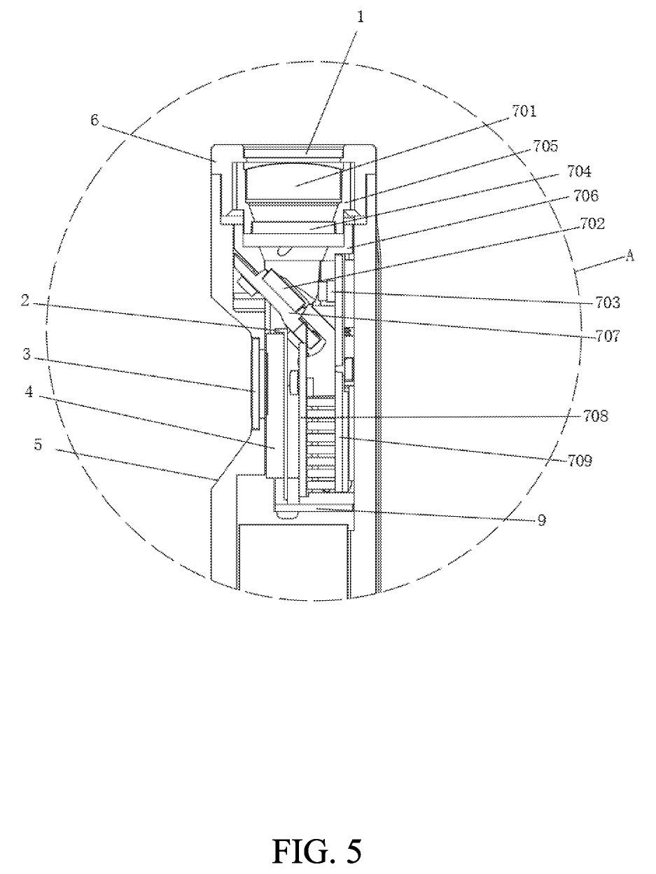

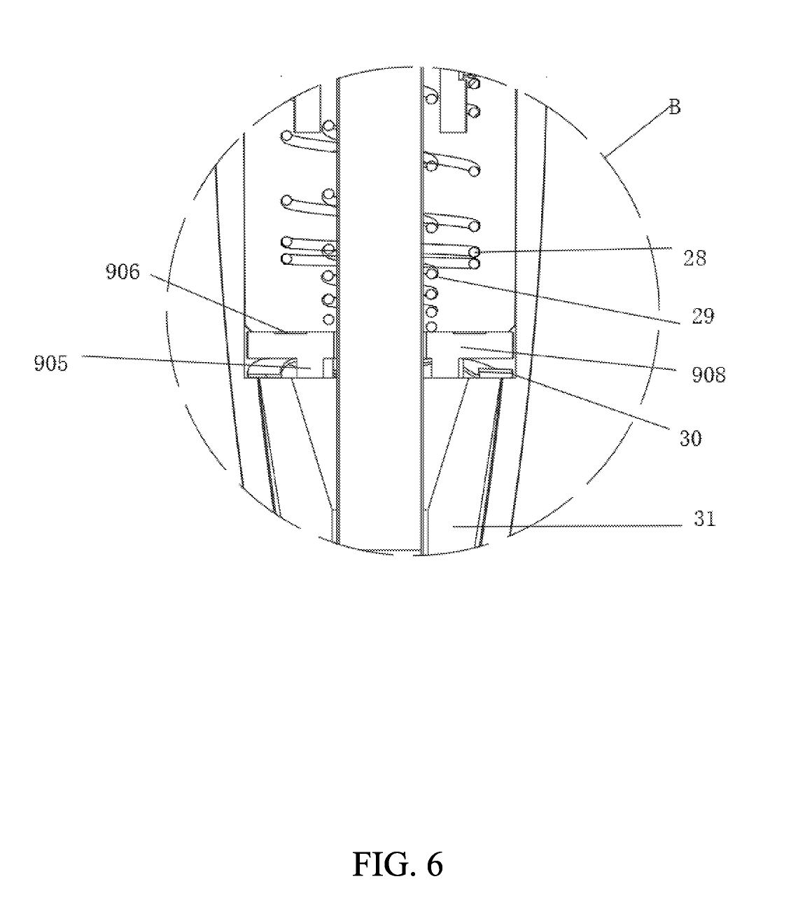

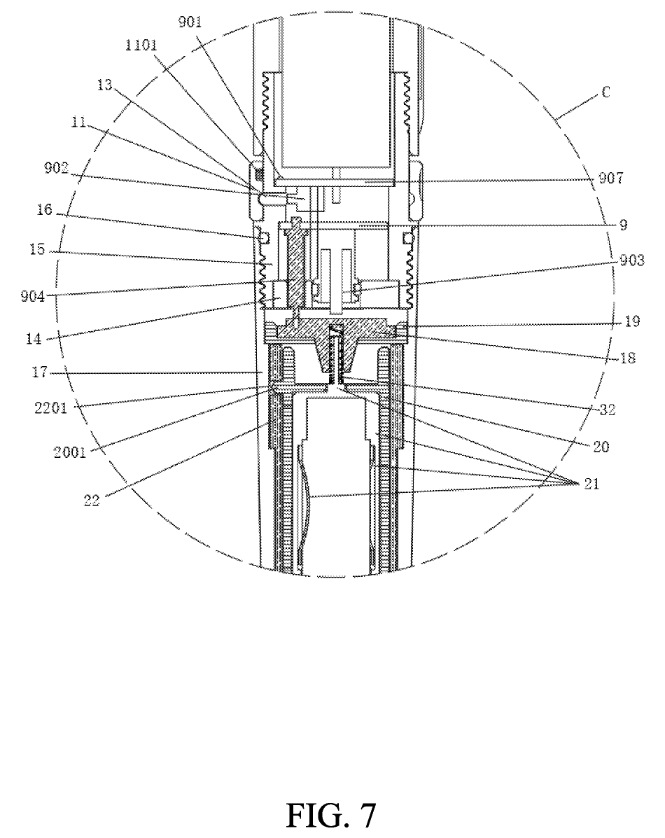

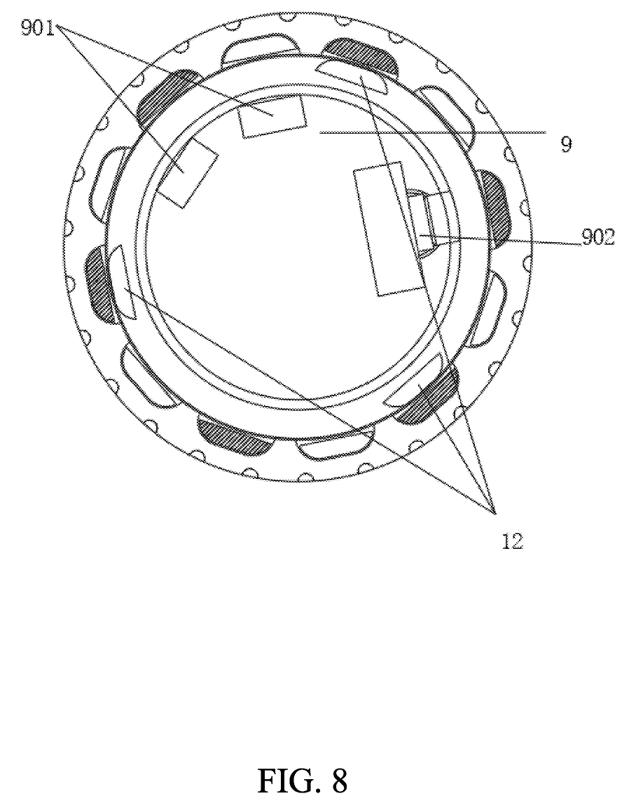

Refer to FIGS. 1-8. An embodiment of the present invention provides a multi-functional pen with integrated laser ranging and illumination, including: a device body consisting of a first pen barrel 5, a pen cover 6 is fixedly connected on an outer wall of a top end of the first pen barrel 5, a pen clip 7 with a protrusion and a display screen bracket 2 are fixedly connected to one side of the outer wall, a device body adapter 15 and a bottom cover 14 are fixedly connected to a bottom end inside, a TYPE-C interface 903 is fixedly connected inside the bottom cover 14, a battery 10 for power supply is disposed inside the first pen barrel 5 at a position near an upper side of the device body adapter 15, and a pen PCB 9 is fixedly connected inside the first pen barrel 5;

a laser ranging assembly is disposed inside the first pen barrel 5 and the pen clip 7, the laser ranging assembly includes a laser transmitting module 710 fixed inside the pen clip 7, a laser transmitting window lens 8 is disposed at a top end of the pen clip 7 and located above the laser transmitting module 710, a ranging module bracket 706 is fixedly connected inside the first pen barrel 5 and used to integrate and fix optical components of a receiving part, a first laser rangefinder module 708 and a second laser rangefinder module 709 are fixedly connected to an outer side of the ranging module bracket 706, a receiving lens sheet bracket 705 and a mirror bracket 707 are fixedly connected on an inner wall of the ranging module bracket 706, a laser receiving lens 701 and a filter 704 are stably supported by the receiving lens sheet bracket 705, and a laser receiving mirror 702 is obliquely fixed by the mirror bracket 707. All the above-mentioned optical components are arranged in coordination under the laser receiving window lens 1 at an inner side of a top end of the first pen barrel 5 for accurately converging and refracting reflected light into a photoelectric sensor 703 located at a lower side during ranging to prevent an optical path from shifting due to assembly tolerances. A ranging result is finally displayed through an external display window lens 3 by a display screen module 4 fixed inside the display screen bracket 2;

a Hall knob control assembly is sleeved on an outer wall of the first pen barrel 5, the assembly includes a knob key 11 rotatably connected to an outer side of the first pen barrel 5, a plurality of first magnets 1101 are fixed in an annular array to an inner wall of the knob key 11, and two Hall sensors 901 are fixed on an outer surface of the pen PCB 9 correspondingly; when the knob key 11 is rotated by a user, the first magnets 1101 are driven to rotate to generate magnetic field changes, the Hall sensors 901 identify such changes and generate signals, and at the same time, a knob reset magnet 12 fixed on the outer wall of the first pen barrel 5 works in conjunction with an inner side of the first magnets 1101 to generate alternating magnetic interaction, so as to provide a tactile detent sensation during rotation. In addition, a groove is formed in the inner wall of the knob key 11, a ball stud 13 is slidably connected inside the groove, a first key 902 is fixed on an outer wall of the pen PCB 9, and a first waterproof ring 16 is sleeved on an inner wall of the first pen barrel 5; when the knob key 11 is pressed inward, one end of the ball stud 13 extends into the first waterproof ring 16, compresses the first waterproof ring 16 inward, and finally abuts against and triggers the first key 902. The first waterproof ring 16 is utilized not only to ensure sealing and waterproofing in the external environment, but also to realize mechanical transmission of confirmation operation commands;

an illumination assembly is disposed below a device body adapter 15, a top end of the casing refill extending and retracting barrel 17 is fixed to an outer wall of the device body adapter 15, a barrel grip 24 is rotatably connected to an outer side of the casing refill extending and retracting barrel 17, a negative conductive refill extending and retracting sleeve 22 with a refill extending and retracting threaded guide slot 2201 formed in the inner wall is rotatably connected inside the casing refill extending and retracting barrel 17, a guide slot pin for insulating refill sleeve extension and retraction 2001 is fixed on an outer wall of an insulating refill extending and retracting sleeve 20, the pin is slidably connected inside the refill extending and retracting threaded guide slot 2201, the negative conductive refill extending and retracting sleeve 22 is driven to rotate by the barrel grip 24, and the insulating refill extending and retracting sleeve 20 is forced to drive the refill body 23 connected internally and slidably to move downward and extend out against a refill extending and retracting spring 29 sleeved on the outer wall; an insulating refill retaining ring 26 is fixed at a bottom end of an inner wall of the casing refill extending and retracting barrel 17, a refill extending and retracting limiter 27 is disposed at an inner side of the insulating refill retaining ring 26, and a second waterproof ring 25 is sleeved at an outer side of the insulating refill retaining ring 26 at a position near an inner wall of the barrel grip 24;

meanwhile, a spring-loaded pin 904 is fixed at a bottom end of the pen PCB 9, a pen positive adapter conductive female connector 18 abuts against a lower side of the spring-loaded pin 904, a positive insulating sleeve 19 is sleeved on an outer wall of the pen positive adapter conductive female connector 18 in conjunction with a refill conductive sheet 21 fixed on an outer wall of the refill body 23 and a refill top conductive spring 32 which is in contact connection at a top end and abuts against a lower surface of the pen positive adapter conductive female connector 18 to form a positive conduction path for illumination power supply. A light emitting unit 905 is fixed at a bottom end inside the casing refill extending and retracting barrel 17, a refill lamp PCB positive electrode guide ring 906 is fixed above the light emitting unit 905, and a refill lamp light guide ring 31 is sleeved around the periphery of the refill lamp PCB positive electrode guide ring 906. When the refill body 23 slides downward and extends into position, the refill lamp positive electrode conductive spring 28 sleeved at a bottom end of the refill body 23 is compressed accordingly, the bottom end just abuts against an upper surface of the refill lamp PCB positive electrode conductive ring 906, a positive power supply circuit is conducted, the light emitting unit 905 is illuminated, a light source is diffused via the refill lamp light guide ring 31, and meanwhile, a negative path of the system is maintained in conjunction with a refill lamp negative conductive wave spring 30 disposed at the periphery of the bottom end; when the refill body 23 is retracted, the refill lamp positive electrode conductive spring 28 separates from the electrode conductive ring to break the circuit, and the illumination is automatically turned off, so as to achieve a mechanical linkage between writing actions and illumination on-off in a compact space inside the barrel.

Working principle: When it is necessary to use a multi-functional pen with integrated laser ranging and illumination, firstly, a user rotates the external knob key 11 for function switching. As the knob key 11 rotates, a plurality of first magnets 1101 on the inner wall are driven to rotate synchronously, and the Hall sensors 901 on the pen PCB 9 generate coded signals for menu scrolling by detecting magnetic field changes generated by the rotation of the first magnets 1101; meanwhile, the knob reset magnet 12 fixed on the outer wall of the first pen barrel 5 generates alternating magnetic attraction and repulsion with the first magnets 1101 to provide a tactile detent sensation during rotation;

secondly, after a function is selected, the user presses the knob key 11 inward, so that the internal ball stud 13 is driven to slide in the groove toward the inner side, the ball stud 13 compresses the first waterproof ring 16 and abuts against and triggers the first key 902 on the pen PCB 9, thereby completing command input;

then, after receiving the command, the pen PCB 9 controls the operation of the laser transmitting module 710, laser light transmitted by the laser transmitting module 710 disposed in the protrusion of the pen clip 7 passes through the laser transmitting window lens 8 and irradiates a target surface, reflected light enters from the laser receiving window lens 1 at an inner side of a top end of the first pen barrel 5, sequentially converges through the laser receiving lens 701 and passes through the filter 704, then irradiates the laser receiving mirror 702 for refraction, and is finally received by the photoelectric sensor 703; the photoelectric sensor 703 converts optical signals into electrical signals, the pen PCB 9 calculates a target distance and displays a ranging result through the display screen module 4 and the display window lens 3;

next, when writing is to be performed, the user rotates the barrel grip 24, so that the internal negative conductive refill extending and retracting sleeve 22 is driven to rotate, the guide slot pin for insulating refill sleeve extension and retraction 2001 is confined within the refill extending and retracting threaded guide slot 2201, the rotation of the threaded guide slot forces the guide slot pin for insulating refill sleeve extension and retraction 2001 to generate a downward thrust, the insulating refill extending and retracting sleeve 20 and the refill body 23 are driven to move downward against an elastic force of the refill extending and retracting spring 29, so that the refill body 23 extends out of the barrel;

finally, as the refill body 23 extends downward, the illumination assembly is triggered in linkage, the battery 10 supplies power to the pen PCB 9, the current sequentially passes through the spring-loaded pin 904, the pen positive adapter conductive female connector 18, the refill top conductive spring 32, the refill body 23 and the refill conductive sheet 21, and is transmitted to the refill lamp positive electrode conductive spring 28 at the bottom. When the refill body 23 is fully extended into position, a bottom end of the compressed refill lamp positive electrode conductive spring 28 abuts against an upper surface of the refill lamp PCB positive electrode guide ring 906 above the light emitting unit 905, the positive power supply circuit is conducted, the current lights up the light emitting unit 905, and the light source is diffused through the refill lamp light guide ring 31 to illuminate a writing position. When the refill body 23 is retracted by reverse rotation after writing, the bottom end of the refill lamp positive electrode conductive spring 28 separates from the refill lamp PCB positive electrode guide ring 906 to disconnect the positive power supply circuit, and the illumination is automatically turned off.

Although embodiments of the present invention have been shown and described, it will be appreciated by those of ordinary skill in the art that a variety of changes, modifications, substitutions and variations can be made to these embodiments without departing from the principle and spirit of the present invention, and the scope of the present invention is limited by the appended claims and equivalents thereof.

What is claimed is:

1. A multi-functional pen with integrated laser ranging and illumination, comprising a device body, wherein the device body is internally provided with a control circuit board, the device body is provided with an illumination assembly comprising at least one light emitting unit, and a refill body is assembled inside the device body;
the device body is provided with a laser ranging assembly comprising a laser transmitting module and a laser receiving part, the laser receiving part comprises a photoelectric sensor, and the laser transmitting module and the laser receiving part are electrically or communicatively connected to the control circuit board, respectively.

2. The multi-functional pen with integrated laser ranging and illumination according to claim 1, wherein the device body is further internally provided with a battery, and the device body is further externally provided with a display screen module and a control interaction assembly;
the device body is provided with a display window lens, the display screen module is fixed or installed on the device body through a display screen bracket, and the display window lens is disposed at an outer side of the display screen module;
the battery, the display screen module, and the control interaction assembly are electrically or communicatively connected to the control circuit board, respectively.

3. The multi-functional pen with integrated laser ranging and illumination according to claim 1, wherein the device body comprises a first pen barrel, the device body further comprises a pen cover and a bottom cover, the pen cover and the bottom cover are disposed at two ends of the device body respectively, and an external accessory of the device body is a pen clip connected to the first pen barrel;
the laser transmitting module is disposed in a cavity of the pen clip, and the laser receiving part is disposed on the first pen barrel;
a light emitting unit of the illumination assembly comprises a pen clip LED lamp disposed in a preset area of the pen clip and electrically connected to the pen PCB through an FPC board;
the device body is further internally assembled with an elastic member which is a refill extending and retracting spring sleeved on the refill body.

4. The multi-functional pen with integrated laser ranging and illumination according to claim 3, wherein the laser receiving part further comprises a laser receiving window lens, a laser receiving lens, and a laser receiving mirror, and the laser ranging assembly further comprises a laser transmitting window lens;
the laser transmitting window lens is disposed in the cavity of the pen clip and located on a light emitting path of the laser transmitting module;
the laser receiving window lens is disposed at an end of the first pen barrel corresponding to light reception, and the laser receiving lens, the laser receiving mirror, and the photoelectric sensor are sequentially arranged along a transmission direction of a laser receiving optical path.

5. The multi-functional pen with integrated laser ranging and illumination according to claim 4, wherein the laser receiving part further comprises a ranging module bracket, a first laser rangefinder module, a second laser rangefinder module, a receiving lens sheet bracket, a mirror bracket, and a filter, the ranging module bracket is installed inside the first pen barrel, the first laser rangefinder module and the second laser rangefinder module are connected to an outer side of the ranging module bracket, the receiving lens sheet bracket and the mirror bracket are assembled on corresponding inner wall surfaces of the ranging module bracket respectively, the laser receiving lens and the filter are assembled inside the receiving lens sheet bracket, and the laser receiving mirror is disposed on a supporting surface of the mirror bracket.

6. The multi-functional pen with integrated laser ranging and illumination according to claim 2, wherein the control interaction assembly comprises a Hall knob control assembly comprising a knob key, first magnets, Hall sensors, a knob reset magnet, a ball stud, a first key, a first waterproof ring, and a second waterproof ring;
the device body comprises a first pen barrel, the knob key is rotatably connected to the first pen barrel, the first waterproof ring and the second waterproof ring are disposed on corresponding mating surfaces of the first pen barrel, a groove is formed in an inner wall of the knob key, the ball stud is slidably connected inside the groove, the first key is connected to the control circuit board, and one end of the ball stud extends into the first waterproof ring and abuts against an outer side of the first key;
a plurality of the first magnets are arranged in an array on the inner wall of the knob key, two of the Hall sensors are connected to the control circuit board, and the knob reset magnet is disposed on the first pen barrel opposite to the first magnets.

7. The multi-functional pen with integrated laser ranging and illumination according to claim 2, wherein the device body comprises an upper half part of the device body and a lower half part of the device body, the upper half part of the device body is detachably connected with the lower half part of the device body, and a device body adapter is disposed between the upper half part of the device body and the lower half part of the device body;
the pen PCB and the battery are disposed inside the upper half part of the device body, and a TYPE-C interface connected to the battery is disposed in an inner cavity of the upper half part of the device body; the refill body is assembled inside the lower half part of the device body;
mutually adapted conductive contacts are disposed at a junction of the upper half part of the device body and the lower half part of the device body respectively; when the upper half part of the device body is connected to the lower half part of the device body, the battery forms a closed electrical circuit with the lower half part of the device body through the conductive contacts.

8. The multi-functional pen with integrated laser ranging and illumination according to claim 7, wherein the light emitting unit of the illumination assembly further comprises an LED light ring disposed in an area of the lower half part of the device body corresponding to a refill end;
the lower half part of the device body is internally provided with an extending and retracting assembly working in conjunction with the refill body, and the extending and retracting assembly comprises a casing refill extending and retracting barrel, a barrel grip, a negative conductive refill extending and retracting sleeve and an insulating refill extending and retracting sleeve and further comprises an insulating refill retaining ring, a refill extending and retracting limiter, and a refill lamp negative conductive wave spring;
the casing refill extending and retracting barrel is connected to the upper half part of the device body, the barrel grip is rotatably connected to the outer side of the casing refill extending and retracting barrel, the insulating refill retaining ring is installed in conjunction with the refill extending and retracting limiter, and the refill lamp negative conductive wave spring is disposed on a negative conduction path of the LED light ring;
the negative conductive refill extending and retracting sleeve is rotatably connected inside the casing refill extending and retracting barrel, a refill extending and retracting threaded guide slot is formed in an inner wall of the negative conductive refill extending and retracting sleeve, a guide slot pin for insulating refill sleeve extension and retraction is disposed on an outer wall of the insulating refill extending and retracting sleeve, the guide slot pin for insulating refill sleeve extension and retraction is slidably connected inside the refill extending and retracting threaded guide slot, and the refill body is slidably connected inside the insulating refill extending and retracting sleeve.

9. The multi-functional pen with integrated laser ranging and illumination according to claim 8, wherein both the casing refill extending and retracting barrel and the refill body are made of conductive materials; the casing refill extending and retracting barrel is electrically connected to a negative electrode of the LED light ring;
the extending and retracting assembly further comprises a spring-loaded pin, a pen positive adapter conductive female connector, a refill conductive sheet, a refill lamp positive electrode conductive spring and a refill top conductive spring, and the extending and retracting assembly further comprises a positive insulating sleeve sleeved on an outer side of the pen positive adapter conductive female connector and a refill lamp PCB positive electrode guide ring, wherein the refill lamp PCB positive electrode guide ring is electrically connected to the pen PCB;
the spring-loaded pin is connected to one end of the upper half part of the device body, the pen positive adapter conductive female connector is disposed at a mating end of the spring-loaded pin, and the refill conductive sheet is connected to an outer side of the refill body;
the refill lamp positive electrode conductive spring and the refill top conductive spring are disposed at two opposite ends of the refill body respectively;
the extending and retracting assembly has a refill extended state and a refill retracted state; in the refill extended state, the refill top conductive spring abuts against the pen positive adapter conductive female connector, and the refill body is connected to a positive electrode of the LED light ring through the springs at the two opposite ends;
in the refill retracted state, the refill top conductive spring is separated from the pen positive adapter conductive female connector.

10. The multi-functional pen with integrated laser ranging and illumination according to claim 8, wherein the LED light ring comprises a white-light LED illuminant, an area of the lower half part of the device body corresponding to the refill end is further provided with a refill lamp light guide ring made of a light-transmissive material, and the refill lamp light guide ring is located on a light emitting path of the LED light ring.
